(19) United States
(12) Patent Application Publication
(10) Pub. No.: US 2024/0267928 A1
(43) Pub. Date: Aug. 8, 2024

(54) APPARATUS AND METHOD OF WIRELESS COMMUNICATION OF MULTIPLE PHYSICAL DOWNLINK SHARED CHANNELS, PDSCHS

(71) Applicant: GUANGDONG OPPO MOBILE TELECOMMUNICATIONS CORP., LTD., Dongguan (CN)

(72) Inventor: Hao LIN, Neuilly-sur-Seine (FR)

(73) Assignee: GUANGDONG OPPO MOBILE TELECOMMUNICATIONS CORP., LTD., Dongguan (CN)

(21) Appl. No.: 18/621,697

(22) Filed: Mar. 29, 2024

Related U.S. Application Data
(63) Continuation of application No. PCT/IB2021/000779, filed on Sep. 30, 2021.

(51) Int. Cl. H04W 72/231; H04L 5/00; H04W 72/1273; H04W 76/20

(52) U.S. Cl. CPC H04W 72/231; H04L 5/0051; H04W 72/1273; H04W 76/20

(57) ABSTRACT

A method of wireless communication, a user equipment and a base station are provided. The method by a user equipment (UE) includes being configured, by a base station, with a downlink control information (DCI) scheduling a first set of physical downlink shared channels (PDSCHs) and/or a second set of PDSCHs, and being configured, by the base station, with a first transmission reception point (TRP) corresponding a first transmission configuration indication (TCI) state and/or a second TRP corresponding a second TCI state. The first TCI state is used for reception of at least a part of the first set of PDSCHs.

### CROSS-REFERENCE TO RELATED APPLICATION

This is a continuation of International Patent Application No. PCT/IB2021/000779, filed on Sep. 30, 2021, the disclosure of which is hereby incorporated by reference in its entirety.

### BACKGROUND OF DISCLOSURE

In an unlicensed band, an unlicensed spectrum is a shared spectrum. Communication equipment in different communication systems can use the unlicensed spectrum as long as the unlicensed meets regulatory requirements set by countries or regions on a spectrum. There is no need to apply for a proprietary spectrum authorization from a government.

In order to allow various communication systems that use the unlicensed spectrum for wireless communication to coexist friendly in the spectrum, some countries or regions specify regulatory requirements that must be met to use the unlicensed spectrum. For example, a communication device follows a listen before talk (LBT) or channel access procedure, that is, the communication device needs to perform a channel sensing before transmitting a signal on a channel. When an LBT outcome illustrates that the channel is idle, the communication device can perform signal transmission; otherwise, the communication device cannot perform signal transmission. In order to ensure fairness, once a communication device successfully occupies the channel, a transmission duration cannot exceed a maximum channel occupancy time (MCOT). LBT mechanism is also called a channel access procedure. In new radio (NR) Release 16, there are different types of channel access procedures, e.g., type 1, type 2A, type 2B and type 2C channel access procedures as described in TS 37.213.

In Release (Rel.) 15 and Rel. 16 of new radio (NR) system, a resource allocation for downlink data such as physical downlink shared channel (PDSCH) has been specified in TS 38.214 section 5. A PDSCH may be scheduled by a downlink control information (DCI) format. The PDSCH contains a transport block corresponding to a hybrid automatic repeat request (HARQ) process number.

### SUMMARY

The present disclosure relates to the field of communication systems, and more particularly, to a method of wireless communication, a user equipment and a base station.

In a first aspect of the present disclosure, a method of wireless communication by a user equipment (UE) comprises being configured, by a base station, with a downlink control information (DCI) scheduling a first set of physical downlink shared channels (PDSCHs) and/or a second set of PDSCHs, and being configured, by the base station, with a first transmission reception point (TRP) corresponding a first transmission configuration indication (TCI) state and/or a second TRP corresponding a second TCI state, wherein the first TCI state is used for reception of at least a part of the first set of PDSCHs.

In a second aspect of the present disclosure, a user equipment comprises a memory, a transceiver, and a processor coupled to the memory and the transceiver. The processor is configured, by a base station, with a downlink control information (DCI) scheduling a first set of physical downlink shared channels (PDSCHs) and/or a second set of PDSCHs, and the processor is configured, by the base station, with a first transmission reception point (TRP) corresponding a first transmission configuration indication (TCI) state and/or a second TRP corresponding a second TCI state, wherein the first TCI state is used for reception of at least a part of the first set of PDSCHs.

In a third aspect of the present disclosure, abase station comprises a memory, a transceiver, and a processor coupled to the memory and the transceiver. The processor is configured to configure, to a user equipment (UE), a downlink control information (DCI) scheduling a first set of physical downlink shared channels (PDSCHs) and/or a second set of PDSCHs, and the processor is configured to configure, to the UE, a first transmission reception point (TRP) corresponding a first transmission configuration indication (TCI) state and/or a second TRP corresponding a second TCI state, wherein the first TCI state is used for reception of at least a part of the first set of PDSCHs.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station (e.g., gNB) of communication in a communication network system according to an embodiment of the present disclosure.

FIG. 2 is a flowchart illustrating a method of wireless communication performed by a user equipment (UE) according to an embodiment of the present disclosure.

FIG. 3 is a flowchart illustrating a method of wireless communication performed by a base station according to an embodiment of the present disclosure.

FIG. 4 illustrates an example that a DCI format schedules a set of PDSCHs according to an embodiment of the present disclosure.

FIG. 5 illustrates an example that a DCI format schedules a set of PDSCHs according to an embodiment of the present disclosure.

FIG. 6 illustrates an example that a DCI format schedules a set of PDSCHs according to an embodiment of the present disclosure.

FIG. 7 illustrates an example that a DCI format schedules a set of PDSCHs according to an embodiment of the present disclosure.

FIG. 8 illustrates an example that a DCI format schedules a set of PDSCHs according to an embodiment of the present disclosure.

FIG. 9 illustrates an example that a DCI format schedules a set of PDSCHs according to an embodiment of the present disclosure.

FIG. 10 illustrates an example that a DCI format schedules a set of PDSCHs according to an embodiment of the present disclosure.

FIG. 11 illustrates an example that a DCI format schedules a set of PDSCHs according to an embodiment of the present disclosure.

FIG. 12 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In Release (Rel.) 15 and Rel. 16 of new radio (NR) system, a resource allocation for downlink data such as physical downlink shared channel (PDSCH) has been specified in TS 38.214 section 5. A PDSCH may be scheduled by a downlink control information (DCI) format. The PDSCH contains a transport block corresponding to a hybrid automatic repeat request (HARQ) process number. However, in some cases, e.g., high throughput requested application such as virtual reality (VR)/augmented reality (AR), or non-terrestrial communications as described in TR 38.811 or TS 38.821, a user equipment (UE) needs to receive PDSCHs carrying different transport blocks consecutively in time domain. In some extreme cases, the UE receives the PDSCHs in consecutive slots. For such applications, if a network follows Rel.15 or Rel.16 specifications, the network needs to spend many DCIs in order to schedule these PDSCH transmissions. Obviously, it could consume a lot of signaling overhead.

Therefore, there is a need for an apparatus and a method of wireless communication, which can solve issues in the prior art, reduce a signaling overhead, provide a method for multiple PDSCH scheduling, provide a good communication performance, and/or provide high reliability.

An object of the present disclosure is to propose an apparatus (such as a user equipment (UE) and/or a base station) and a method of wireless communication, which can solve issues in the prior art, reduce a signaling overhead, provide a method for multiple PDSCH scheduling, provide a good communication performance, and/or provide high reliability.

For uplink transmissions or downlink transmissions in a shared spectrum, a user equipment (UE) or a gNB may perform a channel access procedure before transmitting one or more uplink transmissions or one or more downlink transmissions in a channel. The channel access procedure comprises sensing a channel to determine whether the channel is idle or busy. Optionally, a channel access procedure may comprise at least a type 1 channel access according to section 4.2.1.1 of TS37.213, or a type 2A channel access according to section 4.2.1.2.1 of TS37.213, or a type 2B channel access according to section 4.2.1.2.2 of TS37.213, or a type 2C channel access according to section 4.2.1.2.3 of TS37.213.

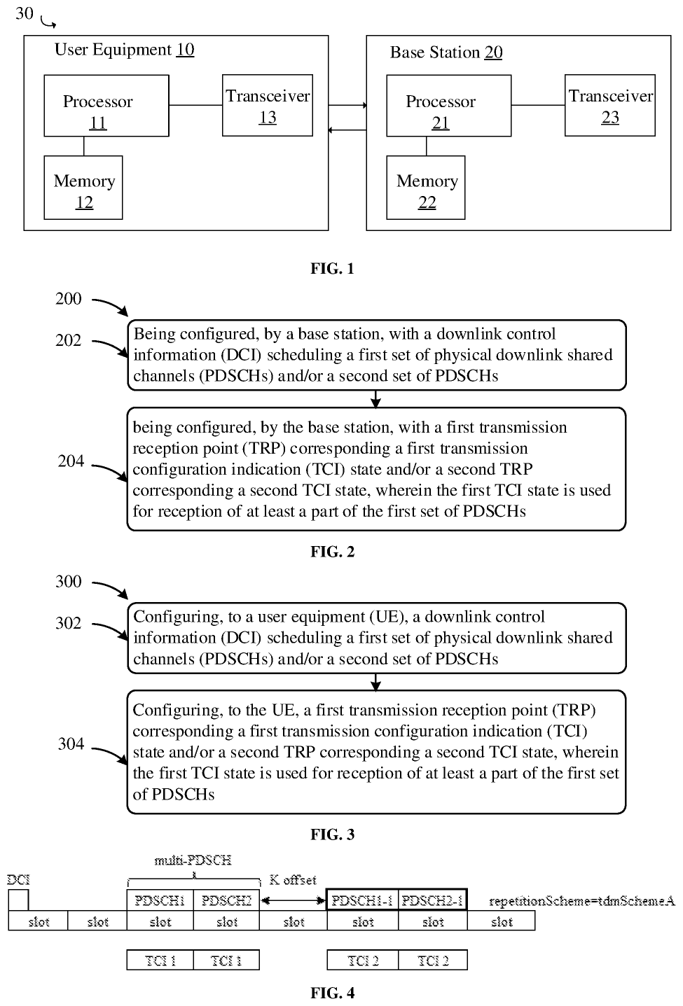

FIG. 1 illustrates that, in some embodiments, one or more user equipments (UEs) 10 and abase station (e.g., gNB) 20 for transmission adjustment in a communication network system 30 according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured, by the base station 20, with a downlink control information (DCI) scheduling a first set of physical downlink shared channels (PDSCHs) and/or a second set of PDSCHs, and the processor is configured, by the base station 20, with a first transmission reception point (TRP) corresponding a first transmission configuration indication (TCI) state and/or a second TRP corresponding a second TCI state, wherein the first TCI state is used for reception of at least a part of the first set of PDSCHs. This can solve issues in the prior art, reduce a signaling overhead, provide a method for multiple PDSCH scheduling, provide a good communication performance, and/or provide high reliability.

In some embodiments, the processor 21 is configured to configure, to the user equipment (UE) 10, a downlink control information (DCI) scheduling a first set of physical downlink shared channels (PDSCHs) and/or a second set of PDSCHs, and the processor is configure, to the UE 10, a first transmission reception point (TRP) corresponding a first transmission configuration indication (TCI) state and/or a second TRP corresponding a second TCI state, wherein the first TCI state is used for reception of at least a part of the first set of PDSCHs. This can solve issues in the prior art, reduce a signaling overhead, provide a method for multiple PDSCH scheduling, provide a good communication performance, and/or provide high reliability.

FIG. 2 illustrates a method 200 of wireless communication by a user equipment (UE) according to an embodiment of the present disclosure. In some embodiments, the method 200 includes: a block 202, being configured, by a base station, with a downlink control information (DCI) scheduling a first set of physical downlink shared channels (PDSCHs) and/or a second set of PDSCHs, and a block 204, being configured, by the base station, with a first transmission reception point (TRP) corresponding a first transmission configuration indication (TCI) state and/or a second TRP corresponding a second TCI state, wherein the first TCI state is used for reception of at least a part of the first set of PDSCHs. This can solve issues in the prior art, reduce a signaling overhead, provide a method for PUCCH slot determination for the multiple PDSCH scheduling, provide a good communication performance, and/or provide high reliability.

FIG. 3 illustrates a method 300 of wireless communication by a base station according to an embodiment of the present disclosure. In some embodiments, the method 300 includes: a block 302, configuring, to a user equipment (UE), a downlink control information (DCI) scheduling a first set of physical downlink shared channels (PDSCHs) and/or a second set of PDSCHs, and a block 304, configuring, to the UE, a first transmission reception point (TRP) corresponding a first transmission configuration indication (TCI) state and/or a second TRP corresponding a second TCI state, wherein the first TCI state is used for reception of at least a part of the first set of PDSCHs. This can solve issues in the prior art, reduce a signaling overhead, provide a method for multiple PDSCH scheduling, provide a good communication performance, and/or provide high reliability.

In some embodiments, the first set of PDSCHs comprises a first PDSCH and a second PDSCH, and the first TCI state is used for reception of the first PDSCH and the second PDSCH of the first set of PDSCHs. In some embodiments, the first PDSCH and the second PDSCH of the first set of PDSCHs carry different transport blocks (TBs) and/or the first PDSCH and the second PDSCH of the first set of PDSCHs are different. In some embodiments, the first PDSCH and the second PDSCH of the first set of PDSCHs carry the same TB and/or the first PDSCH and the second PDSCH of the first set of PDSCHs are same. In some embodiments, the second set of PDSCHs comprises a first PDSCH and a second PDSCH, and the second TCI state is used for reception of the first PDSCH and the second PDSCH of the second set of PDSCHs. In some embodiments, the first PDSCH and the second PDSCH of the second set of PDSCHs carry different transport blocks (TBs) and/or the first PDSCH and the second PDSCH of the second set of PDSCHs are different.

In some embodiments, the first PDSCH and the second PDSCH of the second set of PDSCHs carry the same TB and/or the first PDSCH and the second PDSCH of the second set of PDSCHs are same. In some embodiments, a first symbol of the first PDSCH of the second set of PDSCHs is an offset after a last symbol of the second PDSCH of the first set of PDSCHs. In some embodiments, a value of the offset comprises a part of one symbol or slot, one symbol or slot, or more than one symbol or slot. In some embodiments, the second set of PDSCHs depends on at least one of the following conditions: if a repetition scheme is configured to be tdmScheme A; if indicated demodulation reference signal (DMRS) ports are within one code division multiplexing (CDM) group in one or more DCI field antenna ports; or if the first TCI state and the second TCI state are indicated by a field TCI of the DCI. In some embodiments, if there is only the first TCI state indicated by the DCI field TCI or if there is only the first TCI state can be indicated by the DCI field TCI, there is none of the second set of PDSCHs.

In some embodiments, the first PDSCH of the first set of PDSCHs and the first PDSCH of the second set of PDSCHs have the same TB. In some embodiments, a redundant version (RV) value of the first PDSCH of the first set of PDSCHs and a RV value of the first PDSCH of the second set of PDSCHs are different. In some embodiments, the relationship between the RV value of the first PDSCH of the first set of PDSCHs and the RV value of the first PDSCH of the second set of PDSCHs are pre-defined, wherein the RV value of the first PDSCH of the first set of PDSCHs is indicated in the DCI. In some embodiments, the second PDSCH of the first set of PDSCHs and the second PDSCH of the second set of PDSCHs have the same TB. In some embodiments, a RV value of the second PDSCH of the first set of PDSCHs and a RV value of the second PDSCH of the second set of PDSCHs are different. In some embodiments, the relationship between the RV value of the second PDSCH of the first set of PDSCHs and the RV value of the second PDSCH of the second set of PDSCHs are pre-defined, wherein the RV value of the second PDSCH of the first set of PDSCHs is indicated in the DCI.

In some embodiments, a PDSCH mapping type is type B. In some embodiments, a first symbol of the first PDSCH of the second set of PDSCHs is a first offset after a last symbol of the first PDSCH of the first set of PDSCHs. In some embodiments, a first symbol of the second PDSCH of the second set of PDSCHs is a second offset after a last symbol of the second PDSCH of the first set of PDSCHs. In some embodiments, a value of the first offset and/or a value of the second offset comprises a part of one symbol or slot, one symbol or slot, or more than one symbol or slot. In some embodiments, the first offset and the second offset, are same or different, In some embodiments, the first PDSCH of the first set of PDSCHs and the first PDSCH of the second set of PDSCHs have the same TB. In some embodiments, a RV value of the first PDSCH of the first set of PDSCHs and a RV value of the first PDSCH of the second set of PDSCHs are different. In some embodiments, the RV value of the first PDSCH of the first set of PDSCHs and the RV value of the first PDSCH of the second set of PDSCHs are pre-defined.

In some embodiments, the second PDSCH of the first set of PDSCHs and the second PDSCH of the second set of PDSCHs have the same TB. In some embodiments, a RV value of the second PDSCH of the first set of PDSCHs and a RV value of the second PDSCH of the second set of PDSCHs are different. In some embodiments, the RV value of the second PDSCH of the first set of PDSCHs and the RV value of the second PDSCH of the second set of PDSCHs are pre-defined. In some embodiments, the second set of PDSCHs depends on at least one of the following conditions: if a repetition scheme is configured to be tdmScheme A; if indicated DMRS ports are within one CDM group in one or more DCI field antenna ports; or if the first TCI state and the second TCI state are indicated by a field TCI of the DCI. In some embodiments, if there is only the first TCI state indicated by the DCI field TCI or if there is only the first TCI state can be indicated by the DCI field TCI, there is none of the second set of PDSCHs. In some embodiments, the first PDSCH and the second PDSCH of the first set of PDSCHs are in different slots and occupy respectively a first set of resource blocks (RBs) and a second set of RBs.

In some embodiments, the first set of RBs and the second set of RB of the first set of PDSCHs have the same RB or have equal number of RBs. In some embodiments, the first PDSCH and the second PDSCH of the second set of PDSCHs are in a first slot and a second slot, respectively and occupy respectively a first set of resource blocks (RBs) and a second set of RBs. In some embodiments, the first set of RBs and the second set of RB of the second set of PDSCHs have the same RB or have equal number of RBs. In some embodiments, the first set of RBs are in lower part of a third set of RBs in frequency domain, and the second set of RBs are in higher part of the third set of RBs in frequency domain, wherein the third set of RBs are indicated by the DCI. In some embodiments, the third set of RBs are indicated into RB groups (RBGs), where the first set of RBs are RBGs with even index and the second set of RBs are RBGs with odd index. In some embodiments, the first set of RBs and/or the second set of RBs of the second set of PDSCHs are divided into RBGs.

In some embodiments, an even RBG index is allocated for the first PDSCH and the second PDSCH of the first set of PDSCHs, and an odd RBG index is allocated for the first PDSCH and the second PDSCH of the second set of PDSCHs. In some embodiments, the first PDSCH of the first set of PDSCHs and the first PDSCH of the second set of PDSCHs are same PDSCH. In some embodiments, the second PDSCH of the first set of PDSCHs and the second PDSCH of the second set of PDSCHs are same PDSCH. In some embodiments, the first TCI is assumed for the first PDSCH reception and the second TCI is assumed for the second PDSCH reception. In some embodiments, the first TCI state and/or the second TCI state are pre-configured. In some embodiments, the first TCI state and/or the second TCI state are indicated by the DCI. In some embodiments, the DCI comprises a field TCI indicating the first TCI state and/or the second TCI state. In some embodiments, when the field TCI indicates one TCI state, scheduled PDSCHs are transmitted from one TRP. In some embodiments, when the field TCI indicates two TCI states, scheduled PDSCHs are transmitted from two TRPs.

In some embodiments, when at least one PDSCH among the first set of PDSCHs and the second set of PDSCHs is satisfied that a time interval between a last symbol of a PDCCH carrying the DCI and a first symbol of the PDSCH is smaller than a threshold, the first TCI state and/or the second TCI state are pre-configured. In some embodiments, the pre-configured the TCI state and/or the second TCI state correspond to the pre-configured TCI states with the smallest codepoint for DCI field TCI. In some embodiments, when any PDSCH among the first set of PDSCHs and/or the second set of PDSCHs is satisfied that a time interval between a last symbol of a PDCCH carrying the DCI and a first symbol of the PDSCH is greater than or equal to a threshold, the first TCI state and/or the second TCI state are determined by DCI field TCI. In some embodiments, when at least one PDSCH among the first set of PDSCHs is satisfied that a time interval between a last symbol of a PDCCH carrying the DCI and a first symbol of the PDSCH is smaller than a threshold, the first TCI state is pre-configured. In some embodiments, the pre-configured TCI state corresponds to the pre-configured a first TCI state with the smallest codepoint for DCI field TCI.

In some embodiments, the pre-configured TCI state corresponds to a TCI state of a CORESET. In some embodiments, when at least one PDSCH among the first set of PDSCHs is satisfied that a time interval between a last symbol of a PDCCH carrying the DCI and a first symbol of the PDSCH is greater than or equal to a threshold, the first TCI state determined by a first TCI state indicated by the DCI field TCI, wherein the DCI field TCI may indicate one or two TCI states. In some embodiments, when at least one PDSCH among the second set of PDSCHs is satisfied that a time interval between a last symbol of a PDCCH carrying the DCI and a first symbol of the PDSCH is smaller than a threshold, the second TCI state is pre-configured. In some embodiments, the pre-configured TCI state corresponds to the pre-configured a second TCI state with the smallest codepoint for DCI field TCI. In some embodiments, the pre-configured the TCI state corresponds to a TCI state of a CORESET. In some embodiments, when at least one PDSCH among the second set of PDSCHs is satisfied that a time interval between a last symbol of a PDCCH carrying the DCI and a first symbol of the PDSCH is smaller than a threshold, the second TCI state is determined by a second TCI state indicated by the DCI field TCI, wherein the DCI field TCI indicates two TCI states.

In some embodiments, when at least one of the first PDSCH and the second PDSCH of the first set of PDSCHs and/or at least one of the first PDSCH and the second PDSCH of the second set of PDSCHs is not satisfied that a time interval between a reception of the DCI and at least one of the first PDSCH and the second PDSCH of the first set of PDSCHs and/or at least one of the first PDSCH and the second PDSCH of the second set of PDSCHs is greater than or equal to a threshold, the first TCI state and/or the second TCI state are pre-configured. In some embodiments, the pre-configured first TCI state and/or the pre-configured second TCI state are a smallest codepoint among TCI codepoints containing two different TCI states. In some embodiments, when no codepoint containing two different TCI states, the pre-configured first TCI state and/or the pre-configured second TCI state follow a TCI state or a quasi co-location (QCL) assumption of a control resource set (CORESET) used for physical downlink control channel (PDCCH) transmission. In some embodiments, the threshold is configured by the base station. In some embodiments, the threshold is relevant to a capability of the UE.

FIG. 4 illustrates an example that a DCI format schedules a set of PDSCHs according to an embodiment of the present disclosure. In some examples, when a UE is scheduled to receive more than one PDSCH by one single DCI, as illustrated in FIG. 4, where for example one DCI schedules two PDSCHs (such as PDSCH 1 and PDSCH 2) and the two PDSCHs (such as PDSCH 1 and PDSCH 2) carry different TBs. Note that the number of scheduled PDSCHs may be greater than two. When the UE is further configured with multi-TRP, some examples assume that there are two TRP, each corresponds to a transmission beam, or a TCI state. Thus, the UE may assume that the network will transmit two scheduled PDSCHs (such as PDSCH 1 and PDSCH 2) from one TRP (such as TRP 1) and two other scheduled PDSCHs (such as PDSCH 1-1 and PDSCH 2-1) from the other TRP (such as TRP 2). In this case, the UE will assume to use TCI state 1 (such as TCI 1) to receive the first scheduled PDSCHs and use TCI state 2 (such as TCI 2) to receive the second scheduled PDSCHs, where the first scheduled PDSCHs are denoted as PDSCH 1 and PDSCH 2, and the second scheduled PDSCHs are denoted as PDSCH 1-1 and PDSCH 2-1. The first symbol of the PDSCH 1-1 is K offset after the last symbol of PDSCH 2. The value of K refers to K symbols or K slots. In some examples, the presence of the second scheduled PDSCHs, e.g., PDSCH 1-1 and PDSCH 2-1 may depend on at least one of the following conditions: if repetitionScheme is configured to be tdmScheme A, or if the indicated DMRS ports are within one CDM group in the DCI field antenna port(s); or if two TCI states are indicated by the DCI field transmission configuration indication.

FIG. 4 illustrates that, in some examples, when only one TCI state is indicated by the DCI field transmission configuration indication, it refers to one TRP transmission, in this case, there are none of the second scheduled PDSCHs, e.g., PDSCH 1-1 and PDSCH 2-1. In some examples, the PDSCH1 and PDSCH 1-1 are of the same TB. The redundant version (RV) of the PDSCH 1 and PDSCH 1-1 are different. But the relationship between the RV of PDSCH1 and the RB of PDSCH 1-1 are pre-defined. In some examples, the PDSCH2 and PDSCH 2-1 are of the same TB. The redundant version (RV) of the PDSCH 2 and PDSCH 2-1 are different. But the relationship between the RV of PDSCH2 and the RB of PDSCH 2-1 are pre-defined. In some examples, when two TCI states, e.g., TCI 1 and TCI 2, are indicated by the DCI field transmission configuration indication, the first indicated TCI state (TCI 1) is applied for the first scheduled PDSCHs (PDSCH 1 and PDSCH 2). The second indicated TCI state (TCI 2) is applied for the second scheduled PDSCHs (PDSCH 1-1 and PDSCH 2-1).

FIG. 5 illustrates an example that a DCI format schedules a set of PDSCHs according to an embodiment of the present disclosure. In some examples, a single DCI schedules multiple PDSCHs receptions (such as PD 1, PD 2, PD 3) as illustrated in FIG. 5, where the PDSCH mapping type is type B. When the UE is further configured with multi-TRP, in our example we assume there are two TRPs, each corresponds to a transmission beam, or a TCI state. Thus, the UE may assume that the network will transmit PD 1, PD 2, and PD 3 from one TRP (such as TRP 1) and PD 1-1, PD 2-1, and PD 3-1 from the other TRP (such as TRP 2). In this case, the UE will assume to use TCI state 1 (TCI 1) to receive PD 1, PD 2, and PD 3 and use TCI state 2 (TCI 2) to receive PD 1-1, PD 2-1, and PD 3-1. There is a first offset between the last symbol of PD1 and the first symbol of PD1-1. There is a second offset between the last symbol of PD2 and the first symbol of PD2-1. There is a third offset between the last symbol of PD3 and the first symbol of PD3-1. The PD1 and PD1-1 are of the same TB with different RV. The PD2 and PD2-1 are of the same TB with different RV. The PD3 and PD3-1 are of the same TB with different RV. In some examples, the first offset and/or the second offset and/or the third offset are of the same offset. In some examples, the PD1-1, PD2-1 and PD3-1 from the second TRP may depend on at least one of the following conditions: if repetitionScheme is configured to be tdmScheme A, or if the indicated DMRS ports are within one CDM group in the DCI field antenna port(s); or if two TCI states are indicated by the DCI field transmission configuration indication.

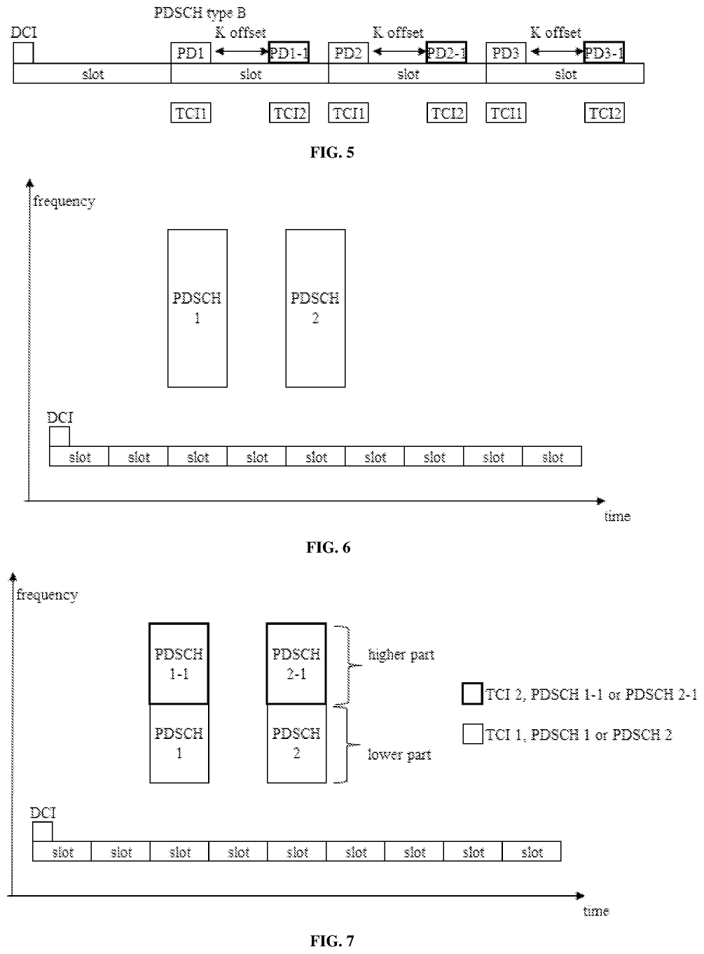

In some examples, as illustrated in FIG. 6, when the UE is scheduled to receive more than one PDSCH by one single DCI, where for example one DCI schedules two PDSCHs (PDSCH1 and PDSCH2) and the two PDSCH carry different TBs. Note that the number of scheduled PDSCH may be greater than two. The two PDSCHs are in different slots and they occupy respectively a first set of RBs and a second set of RBs. In some examples, the first set of RBs are same as the second set of RBs.

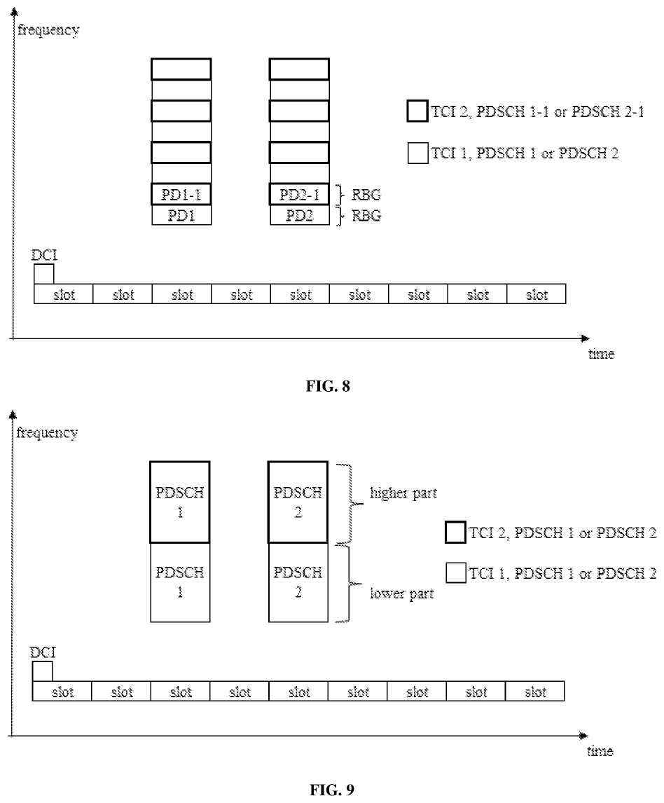

FIG. 7 illustrates an example that a DCI format schedules a set of PDSCHs according to an embodiment of the present disclosure. In some embodiments, when the UE is further configured with multi-TRP, our examples assume that there are two TRP, each corresponds to a transmission beam, or a TCI state. Thus, the UE may assume that the network will transmit two scheduled PDSCHs from one TRP (TRP1) and two other scheduled PDSCHs from the other TRP (TRP2). In this case, the UE will assume to use TCI state 1 (TCI 1) to receive the first scheduled PDSCHs and use TCI state 2 (TCI 2) to receive the second scheduled PDSCHs, where the second scheduled PDSCHs are denoted as PDSCH 1-1 and PDSCH 2-1. In some examples, the first set of RBs and/or the second set of RBs are splitted into two parts, e.g., lower part and higher part in frequency domain as illustrated in FIG. 7. The lower part set of RBs are allocated for PDSCH 1 and PDSCH 2. The higher part set of RBs are allocated for PDSCH 1-1 and PDSCH 1-2. In some examples, the lower part and the higher part set of RBs are equal number of RBs. Optionally, the first and/or the second set of RBs are divided into RB groups (RBG). The definition of RBG can be followed with TS38.214.

The even RBG index can be allocated for PDSCH1 and PDSCH2, the odd RBG index can be allocated for PDSCH1-1 and PDSCH2-1 as illustrated in FIG. 8. In some examples the PDSCH 1 and PDSCH 1-1 are of the same TB. In some examples, PDSCH1 and PDSCH1-1 are of different RVs. In some examples, the PDSCH 2 and PDSCH 2-1 are of the same TB. In some examples, PDSCH2 and PDSCH2-1 are of different RVs. Some examples call it the first mode, i.e., for a same TB, the UE receives different PDSCHs from two different TRP, assuming two different TCI states (TCI 1 and TCI 2). In some examples, when UE determines that there is only one TCI state, the UE assumes that there is only the first scheduled PDSCH reception using the only TCI state for the reception.

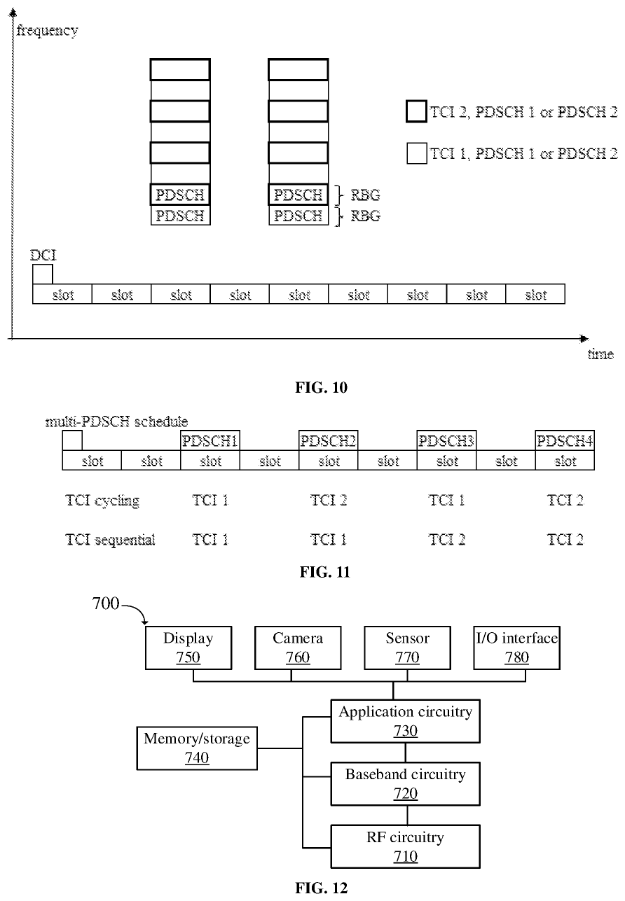

In some examples, the PDSCH from the first TRP and the PDSCH from the second TRP are the same PDSCH, as illustrated in FIG. 9 and FIG. 10. In this example, this can be seen as PDSCH repetition from two different TRPs. The UE assumes to use TCI 1 and TCI 2 to receive the same scheduled PDSCHs (in some examples in FIG. 9 and FIG. 10, PDSCH1 and PDSCH 2) in respective resources. Some examples call it the second mode, i.e., for a same TB, the UE receives PDSCH repetitions (identical PDSCH) from two different TRP, assuming two different TCI states (TCI 1 and TCI 2). In some examples, the network may configure the first mode or the second mode.

In some examples, as illustrated in FIG. 11, when the UE is scheduled to receive more than one PDSCHs by one single DCI, where for example one DCI schedules four PDSCHs (PDSCH 1˜PDSCH 4), where the PDSCHs are carrying different TBs. When the UE is further configured with multi-TRP, some examples assume that there are two TRP, each corresponds to a transmission beam, or a TCI state. Thus, UE may assume to use TCI 1 for PDSCH1 reception and PDSCH 3 reception and assume to use TCI 2 for PDSCH2 reception and PDSCH 4 reception. This is called TCI cycling, it means that for sequential of PDSCH receptions, the TCI states from TCI 1 up to TCI 2 and restart from TCI 1 up to TCI 2. Optionally, the same TCI state (TCI 1) can be assumed for a set of consecutive PDSCHs and then changed to the other TCI state (TCI 2).

In the above examples, the first TCI state (TCI 1) and the second TCI state (TCI 2) may be indicated by the single DCI, where the DCI may contain indication field transmission configuration indication. The indication field may indicate one TCI state or two TCI states. When it indicates one TCI state, the UE assumes that the scheduled PDSCHs are transmitted from one TRP. When it indicates two TCI state, the UE assumes multi-TRP is applied for PDSCH transmission as explained in the above examples. Optionally, the first TCI state and the second TCI state may be pre-configured. In case that all the scheduled PDSCHs are satisfied that the time interval between the DCI reception and the scheduled PDSCH is greater than or equal to a threshold, the first and/or the second TCI states are determined by DCI indication. Optionally, in case that not all the scheduled PDSCHs are satisfied that the time interval between the DCI reception and the scheduled PDSCH is greater than or equal to a threshold, the first and/or the second TCI states are pre-configured. The pre-configured first and/or second TCI states are the smallest codepoint among the TCI codepoints containing two different TCI states. In some examples, when no codepoint containing two different TCI states, the pre-configured TCI state is following TCI state or QCL assumption of the CORESET used for PDCCH transmission. In some examples, the threshold is configured by the network. In some examples, the value of the threshold is relevant to UE capability.

Commercial interests for some embodiments are as follows. 1. Solving issues in the prior art. 2. Reducing a signaling overhead. 3. Providing a method for multiple PDSCH scheduling. 4. Providing a good communication performance. 5. Providing a high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR licensed and non-licensed or shared spectrum communications. Some embodiments of the present disclosure propose technical mechanisms.

FIG. 12 is a block diagram of an example system 700 for wireless communication according to an embodiment of the present disclosure. Embodiments described herein may be implemented into the system using any suitably configured hardware and/or software. FIG. 12 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method by a user equipment (UE), comprising:
being configured, by a base station, with a downlink control information (DCI) scheduling a first set of physical downlink shared channels (PDSCHs) and/or a second set of PDSCHs; and
being configured, by the base station, with a first transmission reception point (TRP) corresponding a first transmission configuration indication (TCI) state and/or a second TRP corresponding a second TCI state, wherein the first TCI state is used for reception of at least a part of the first set of PDSCHs.

2. The method of claim 1, wherein
a presence of the second set of PDSCHs depends on at least one of the following conditions: if a repetition scheme is configured to be tdmScheme A; if indicated demodulation reference signal (DMRS) ports are within one code division multiplexing (CDM) group in one or more DCI field antenna ports; or if the first TCI state and the second TCI state are indicated by a field TCI of the DCI; and
if there is only the first TCI state indicated by the DCI field TCI or if there is only the first TCI state can be indicated by the DCI field TCI, there is none of the second set of PDSCHs.

3. The method of claim 1, wherein
a first PDSCH of the first set of PDSCHs and a first PDSCH of the second set of PDSCHs have the same transport block (TB);
a redundant version (RV) value of the first PDSCH of the first set of PDSCHs and a RV value of the first PDSCH of the second set of PDSCHs are different; and
a relationship between the RV value of the first PDSCH of the first set of PDSCHs and the RV value of the first PDSCH of the second set of PDSCHs are pre-defined, wherein the RV value of the first PDSCH of the first set of PDSCHs is indicated in the DCI.

4. The method of claim 1, wherein
a first PDSCH and a second PDSCH of the first set of PDSCHs are in different slots and occupy respectively a first set of resource blocks (RBs) and a second set of RBs; and
the first set of RBs and the second set of RBs of the first set of PDSCHs have the same RB or have equal number of RBs.

5. The method of claim 1, wherein
the first TCI state and/or the second TCI state are pre-configured; or
the first TCI state and/or the second TCI state are indicated by the DCI.

6. The method of claim 5, wherein
the DCI comprises a field TCI indicating the first TCI state and/or the second TCI state;
when the field TCI indicates one TCI state, scheduled PDSCHs are transmitted from one TRP; and
when the field TCI indicates two TCI states, scheduled PDSCHs are transmitted from two TRPs.

7. A user equipment (UE), comprising:
a memory for storing a computer program;
a transceiver; and
a processor coupled to the memory and the transceiver;
wherein the processor is configured to execute the computer program to:
be configured, by a base station, with a downlink control information (DCI) scheduling a first set of physical downlink shared channels (PDSCHs) and/or a second set of PDSCHs; and
be configured, by the base station, with a first transmission reception point (TRP) corresponding a first transmission configuration indication (TCI) state and/or a second TRP corresponding a second TCI state, wherein the first TCI state is used for reception of at least a part of the first set of PDSCHs.

8. The UE of claim 7, wherein
the first set of PDSCHs comprises a first PDSCH and a second PDSCH, and the first TCI state is used for reception of the first PDSCH and the second PDSCH of the first set of PDSCHs; and
the first PDSCH and the second PDSCH of the first set of PDSCHs carry different transport blocks (TBs) and/or the first PDSCH and the second PDSCH of the first set of PDSCHs are different; or
the first PDSCH and the second PDSCH of the first set of PDSCHs carry the same TB and/or the first PDSCH and the second PDSCH of the first set of PDSCHs are same.

9. The UE of claim 7, wherein
the second set of PDSCHs comprises a first PDSCH and a second PDSCH, and the second TCI state is used for reception of the first PDSCH and the second PDSCH of the second set of PDSCHs; and
the first PDSCH and the second PDSCH of the second set of PDSCHs carry different transport blocks (TBs) and/or the first PDSCH and the second PDSCH of the second set of PDSCHs are different; or the first PDSCH and the second PDSCH of the second set of PDSCHs carry the same TB and/or the first PDSCH and the second PDSCH of the second set of PDSCHs are same.

10. The UE of claim 7, wherein a first symbol of a first PDSCH of the second set of PDSCHs is an offset after a last symbol of a second PDSCH of the first set of PDSCHs.

11. The UE of claim 7, wherein
a second PDSCH of the first set of PDSCHs and a second PDSCH of the second set of PDSCHs have the same transport block (TB);
a redundant version (RV) value of the second PDSCH of the first set of PDSCHs and a RV value of the second PDSCH of the second set of PDSCHs are different; and
a relationship between the RV value of the second PDSCH of the first set of PDSCHs and the RV value of the second PDSCH of the second set of PDSCHs are pre-defined, wherein the RV value of the second PDSCH of the first set of PDSCHs is indicated in the DCI.

12. The UE of claim 7, wherein
a first PDSCH and a second PDSCH of the first set of PDSCHs are in different slots and occupy respectively a first set of resource blocks (RBs) and a second set of RBs;
a first PDSCH and a second PDSCH of the second set of PDSCHs are in different slots and occupy respectively a first set of resource blocks (RBs) and a second set of RBs;
the first set of RBs and the second set of RBs of the first set of PDSCHs have the same RB or have equal number of RBs; and
the first set of RBs and the second set of RBs of the second set of PDSCHs have the same RB or have equal number of RBs.

13. The UE of claim 12, wherein
the first set of RBs and the second set of RBs of the first set of PDSCHs are in lower part of a third set of RBs in frequency domain, and the first set of RBs and the second set of RBs of the second set of PDSCHs are in higher part of the third set of RBs in frequency domain, wherein the third set of RBs are indicated by the DCI; and
the third set of RBs are indicated into RB groups (RBGs), where the first set of RBs and the second set of RBs of the first set of PDSCHs are RBGs with even index, and the first set of RBs and the second set of RBs of the second set of PDSCHs are RBGs with odd index.

14. The UE of claim 7, wherein
when at least one PDSCH among the first set of PDSCHs and the second set of PDSCHs is satisfied that a time interval between a last symbol of a PDCCH carrying the DCI and a first symbol of the PDSCH is smaller than a threshold, the first TCI state and/or the second TCI state are pre-configured;
when any PDSCH among the first set of PDSCHs and/or the second set of PDSCHs is satisfied that a time interval between a last symbol of a PDCCH carrying the DCI and a first symbol of the PDSCH is greater than or equal to a threshold, the first TCI state and/or the second TCI state are determined by DCI field TCI;
when at least one PDSCH among the first set of PDSCHs is satisfied that a time interval between a last symbol of a PDCCH carrying the DCI and a first symbol of the PDSCH is smaller than a threshold, the first TCI state is pre-configured;
when at least one PDSCH among the first set of PDSCHs is satisfied that a time interval between a last symbol of a PDCCH carrying the DCI and a first symbol of the PDSCH is greater than or equal to a threshold, the first TCI state is determined by a first TCI state indicated by the DCI field TCI, wherein the DCI field TCI may indicate one or two TCI states;
when at least one PDSCH among the second set of PDSCHs is satisfied that a time interval between a last symbol of a PDCCH carrying the DCI and a first symbol of the PDSCH is smaller than a threshold, the second TCI state is pre-configured;
when at least one PDSCH among the second set of PDSCHs is satisfied that a time interval between a last symbol of a PDCCH carrying the DCI and a first symbol of the PDSCH is greater than or equal to a threshold, the second TCI state is determined by a second TCI state indicated by the DCI field TCI, wherein the DCI field TCI indicates two TCI states; or
when at least one of a first PDSCH and a second PDSCH of the first set of PDSCHs and/or at least one of a first PDSCH and a second PDSCH of the second set of PDSCHs is not satisfied that a time interval between a reception of the DCI and at least one of the first PDSCH and the second PDSCH of the first set of PDSCHs and/or at least one of the first PDSCH and the second PDSCH of the second set of PDSCHs is greater than or equal to a threshold, the first TCI state and/or the second TCI state are pre-configured.

15. The UE of claim 14, wherein
the pre-configured first TCI state and/or the pre-configured second TCI state are a smallest codepoint among TCI codepoints containing two different TCI states; and
when no codepoint containing two different TCI states, the pre-configured first TCI state and/or the pre-configured second TCI state follow a TCI state or a quasi co-location (QCL) assumption of a control resource set (CORESET) used for physical downlink control channel (PDCCH) transmission.

16. Abase station, comprising:
a memory for storing a computer program;
a transceiver; and
a processor coupled to the memory and the transceiver;
wherein the processor is configured to execute the computer program to:
configure, to a user equipment (UE), a downlink control information (DCI) scheduling a first set of physical downlink shared channels (PDSCHs) and/or a second set of PDSCHs; and
configure, to the UE, a first transmission reception point (TRP) corresponding a first transmission configuration indication (TCI) state and/or a second TRP corresponding a second TCI state, wherein the first TCI state is used for reception of at least a part of the first set of PDSCHs.

17. The base station of claim 16, wherein
the first set of PDSCHs comprises a first PDSCH and a second PDSCH, and the first TCI state is used for reception of the first PDSCH and the second PDSCH of the first set of PDSCHs;
the first PDSCH and the second PDSCH of the first set of PDSCHs carry different transport blocks (TBs) and/or the first PDSCH and the second PDSCH of the first set of PDSCHs are different; or the first PDSCH and the second PDSCH of the first set of PDSCHs carry the same TB and/or the first PDSCH and the second PDSCH of the first set of PDSCHs are same;
the second set of PDSCHs comprises a first PDSCH and a second PDSCH, and the second TCI state is used for reception of the first PDSCH and the second PDSCH of the second set of PDSCHs;
the first PDSCH and the second PDSCH of the second set of PDSCHs carry different transport blocks (TBs) and/or the first PDSCH and the second PDSCH of the second set of PDSCHs are different; or the first PDSCH and the second PDSCH of the second set of PDSCHs carry the same TB and/or the first PDSCH and the second PDSCH of the second set of PDSCHs are same.

18. The base station of claim 16, wherein
a presence of the second set of PDSCHs depends on at least one of the following conditions: if a repetition scheme is configured to be tdmScheme A; if indicated demodulation reference signal (DMRS) ports are within one code division multiplexing (CDM) group in one or more DCI field antenna ports; or if the first TCI state and the second TCI state are indicated by a field TCI of the DCI; and
if there is only the first TCI state indicated by the DCI field TCI or if there is only the first TCI state can be indicated by the DCI field TCI, there is none of the second set of PDSCHs.

19. The base station of claim 16, wherein
a first PDSCH of the first set of PDSCHs and a first PDSCH of the second set of PDSCHs have the same TB;
a redundant version (RV) value of the first PDSCH of the first set of PDSCHs and a RV value of the first PDSCH of the second set of PDSCHs are different; and
a relationship between the RV value of the first PDSCH of the first set of PDSCHs and the RV value of the first PDSCH of the second set of PDSCHs are pre-defined, wherein the RV value of the first PDSCH of the first set of PDSCHs is indicated in the DCI;
a second PDSCH of the first set of PDSCHs and a second PDSCH of the second set of PDSCHs have the same TB;
a RV value of the second PDSCH of the first set of PDSCHs and a RV value of the second PDSCH of the second set of PDSCHs are different; and
a relationship between the RV value of the second PDSCH of the first set of PDSCHs and the RV value of the second PDSCH of the second set of PDSCHs are pre-defined, wherein the RV value of the second PDSCH of the first set of PDSCHs is indicated in the DCI.

20. The base station of claim 16, wherein
when at least one PDSCH among the first set of PDSCHs and the second set of PDSCHs is satisfied that a time interval between a last symbol of a PDCCH carrying the DCI and a first symbol of the PDSCH is smaller than a threshold, the first TCI state and/or the second TCI state are pre-configured; or
when any PDSCH among the first set of PDSCHs and/or the second set of PDSCHs is satisfied that a time interval between a last symbol of a PDCCH carrying the DCI and a first symbol of the PDSCH is greater than or equal to a threshold, the first TCI state and/or the second TCI state are determined by DCI field TCI; or
when at least one PDSCH among the first set of PDSCHs is satisfied that a time interval between a last symbol of a PDCCH carrying the DCI and a first symbol of the PDSCH is smaller than a threshold, the first TCI state is pre-configured; or
when at least one PDSCH among the first set of PDSCHs is satisfied that a time interval between a last symbol of a PDCCH carrying the DCI and a first symbol of the PDSCH is greater than or equal to a threshold, the first TCI state is determined by a first TCI state indicated by the DCI field TCI, wherein the DCI field TCI may indicate one or two TCI states; or
when at least one PDSCH among the second set of PDSCHs is satisfied that a time interval between a last symbol of a PDCCH carrying the DCI and a first symbol of the PDSCH is smaller than a threshold, the second TCI state is pre-configured; or
when at least one PDSCH among the second set of PDSCHs is satisfied that a time interval between a last symbol of a PDCCH carrying the DCI and a first symbol of the PDSCH is greater than or equal to a threshold, the second TCI state is determined by a second TCI state indicated by the DCI field TCI, wherein the DCI field TCI indicates two TCI states; or
when at least one of a first PDSCH and a second PDSCH of the first set of PDSCHs and/or at least one of a first PDSCH and a second PDSCH of the second set of PDSCHs is not satisfied that a time interval between a reception of the DCI and at least one of the first PDSCH and the second PDSCH of the first set of PDSCHs and/or at least one of the first PDSCH and the second PDSCH of the second set of PDSCHs is greater than or equal to a threshold, the first TCI state and/or the second TCI state are pre-configured.
